(19) United States
(12) Patent Application Publication
(10) Pub. No.: US 2016/0357486 A1
(43) Pub. Date: Dec. 8, 2016

(54) DATA PROVIDING DEVICE, DATA PROVIDING METHOD, AND COMPUTER PROGRAM

(71) Applicant: Konica Minolta, Inc., Tokyo (JP)

(72) Inventors: Yu SONODA, Yawato-cho (JP); Takashi SUGAYA, Toyokawa-shi (JP); Shinichi ASAI, Gamagori-shi (JP); Hideyuki MATSUDA, Osaka (JP)

(73) Assignee: Konica Minolta, Inc., Tokyo (JP)

(21) Appl. No.: 15/172,632

(22) Filed: Jun. 3, 2016

(30) Foreign Application Priority Data
Jun. 4, 2015 (JP) 2015-114177

(51) Int. Cl. G06F 3/12

(52) U.S. Cl. CPC G06F 3/1204; G06F 3/1212; G06F 3/1258; G06F 3/126

(57) ABSTRACT

A data providing device includes a transmission unit configured to transmit at least one of a plurality of pieces of data to a terminal device, and a compression unit configured to compress the at least one of the plurality of pieces of data, the data providing device including: a reception unit configured to receive, from the terminal device, specification of one or a plurality of pieces of target data that are transmission targets among the plurality of pieces of data, wherein, in a case where the number of pieces of the one or the plurality of pieces of target data is less than a predetermined number, the transmission unit transmits the target data to the terminal device without the compression unit compressing the target data.

The entire disclosure of Japanese Patent Application No. 2015-114177 filed on Jun. 4, 2015 including description, claims, drawings, and abstract are incorporated herein by reference in its entirety.

### BACKGROUND OF THE INVENTION

### Field of the Invention

The present invention relates to a technology of providing data to a terminal device.

### Description of the Related Art

Image forming devices combining functions of a copier, a network printer, a facsimile, a scanner and the like are widely spread. Such an image forming device is called an “all-in-one machine” or an “MFP (Multi Function Peripheral)”, for example. Moreover, in recent years, a box function has come to be provided to the image forming device.

The box function is a function for providing a storage area called a “box” or a “personal box” to each user so as to allow each user to save and manage data in units of files by using his/her storage area. That is, it has a function of a file server.

A user may use a file saved in the box by operating a touch panel display of the image forming device, or may use the file by connecting a terminal device to the image forming device and by operating the terminal device.

As a technology related to data management, the following technology is proposed. A data storage device includes a monitor section and a keyboard to be used by a user to input an acceptable waiting time to a data distribution device for transmitting accumulated content data to the user in response to a request, an image data processing section for compressing data to be transmitted, according to the acceptable waiting time input to the monitor section and the keyboard, and an image transmission section for transmitting compressed data to the user (JP 2007-28646 A).

An image processing device converts image data into a predetermined transmitting format in turn from a read page before images are read from all pages of originals, causes, upon completion of reading of all the pages of the originals, a transmission section to transmit image data of a page which has already been converted into the transmitting format, and causes image data of a page which is not yet converted into the transmitting format to be converted into the transmitting format and causes the transmission section to transmit the image data (JP 2013-214951 A).

As described above, conventionally, data was provided to a user after being processed in various manners, such as after being compressed or being converted into a predetermined format.

The processing methods above can offer a certain convenience to users, but the convenience of users is desired to be further increased.

### SUMMARY OF THE INVENTION

In view of the above circumstance, the present invention has its object to increase convenience in the provision of data to a user compared to the past.

To achieve the abovementioned object, according to an aspect, a data providing device reflecting one aspect of the present invention comprises a transmission unit configured to transmit at least one of a plurality of pieces of data to a terminal device, and a compression unit configured to compress the at least one of the plurality of pieces of data, the data providing device comprising: a reception unit configured to receive, from the terminal device, specification of one or a plurality of pieces of target data that are transmission targets among the plurality of pieces of data, wherein, in a case where the number of pieces of the one or the plurality of pieces of target data is less than a predetermined number, the transmission unit transmits the target data to the terminal device without the compression unit compressing the target data.

In a case where the number of pieces of the one or the plurality of pieces of target data is equal to or more than the predetermined number, the transmission unit preferably transmits the target data after the target data is compressed by the compression unit.

In a case where the number of the one or the plurality of pieces of target data is equal to or more than the predetermined number, if a degree of congestion in a communication channel between the terminal device and the data providing device is equal to or greater than a predetermined level, the transmission unit preferably transmits the target data after the target data is compressed by the compression unit, and if the degree of congestion is less than the predetermined level, the transmission unit preferably transmits the target data without the compression unit compressing the target data.

In a case where the number of the one or the plurality of pieces of target data is equal to or more than the predetermined number, if a level of a current load on the data providing device is equal to or greater than a predetermined level, the transmission unit preferably transmits the target data without the compression unit compressing the target data, and if the level of the current load is less than the predetermined level, the transmission unit preferably transmits the target data after the target data is compressed by the compression unit.

In a case where the number of the one or the plurality of pieces of target data is equal to or more than the predetermined number, if the data providing device is performing a specific process, the transmission unit preferably transmits the target data without the compression unit compressing the target data. The specific process is preferably a process of raster image processor (RIP).

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram showing an example of an overall configuration of a document management system;

FIG. 2 is a diagram showing an example hardware configuration of an image forming device;

FIG. 3 is a diagram showing an example functional configuration of the image forming device;

FIG. 4 is a diagram showing an example of a web page;

FIG. 5 is a diagram showing an example of a standard table;

FIG. 6 is a diagram showing an example of relationships of compression times and the like at the time of execution of specific processes;

FIG. 7 is a flow chart describing an example of a flow of a compression/non-compression determination process;

FIG. 8 is a flow chart describing an example of an overall flow of a process according to a file providing program;

FIG. 9 is a flow chart describing an example modification of the flow of the compression/non-compression determination process;

FIG. 10 is a flow chart describing an example modification of the flow of the compression/non-compression determination process; and

FIG. 11 is a flow chart describing an example modification of the flow of the compression/non-compression determination process.

### DESCRIPTION OF THE PREFERRED EMBODIMENTS

Hereinafter, an embodiment of the present invention will be described with reference to the drawings. However, the scope of the invention is not limited to the illustrated examples.

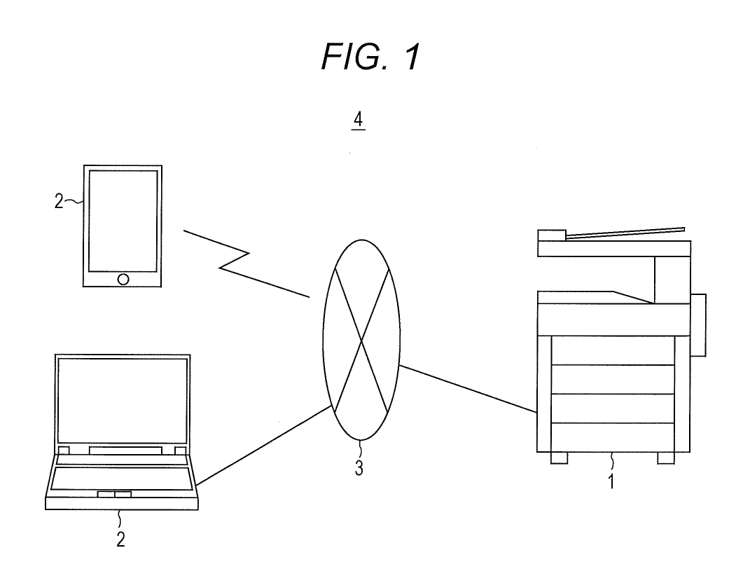

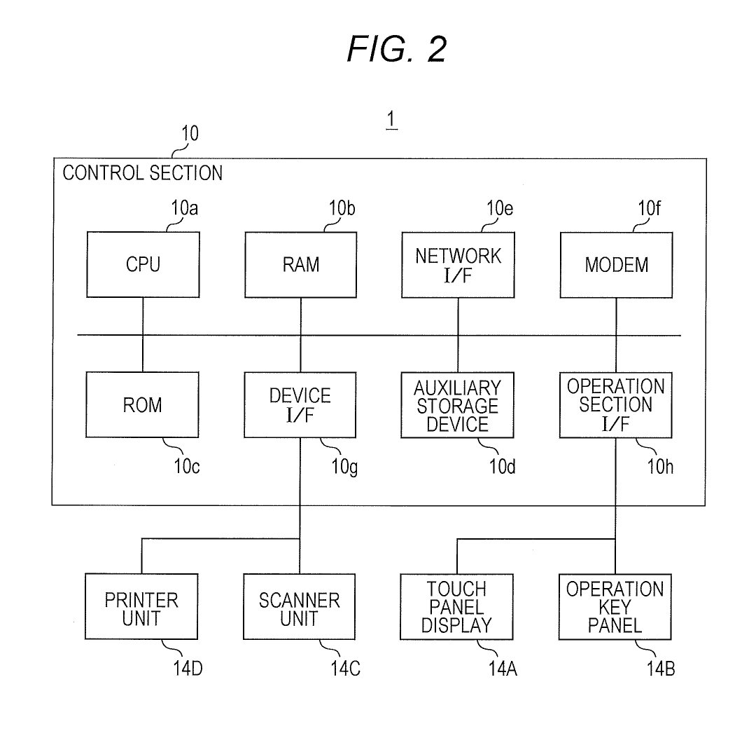

FIG. 1 is a diagram showing an example of an overall configuration of a document management system 4. FIG. 2 is a diagram showing an example hardware configuration of an image forming device 1.

As shown in FIG. 1, the document management system 4 is configured from an image forming device 1, a terminal device 2, a communication line 3, and the like.

The image forming device 1 and the terminal device 2 are capable of communicating with each other over the communication line 3. As the communication line 3, the Internet, a LAN (Local Area Network) line, a public line, a dedicated line or the like is used.

The image forming device 1 is an image processing device combining functions of a copier, a network printer, a facsimile, a scanner, a box, and the like. Generally, it is referred to as an “all-in-one machine” or an “MFP (Multi Function Peripheral)”, for example.

A network printing function is a function of receiving image data from the terminal device 2, and printing the image on paper. At this time, the image data is developed into bit map data by the function of a RIP (Raster Image Processor). In the present embodiment, the RIP is realized by a CPU 10a (see FIG. 2) executing a program.

A box function is a function for providing a storage area called a “box” or a “personal box” to each user so as to allow each user to save and manage data in units of files by using his/her storage area. That is, it is a function of a file server. The box corresponds to a “folder” or a “directory” of a personal computer.

For example, a document file, a diagram file and the like'may be saved and managed. These files may be obtained by causing a scanner unit 14C (see FIG. 2) to scan a sheet on which a document or a diagram is printed, for example. The files may also be created by a personal computer, or may be downloaded from a server on the Internet.

As shown in FIG. 2, the image forming device 1 is configured from a control section 10, a touch panel display 14A, an operation key panel 14B, a scanner unit 14C, a printer unit 14D, and the like.

The control section 10 is configured from a CPU (Central Processing Unit) 10a, a RAM (Random Access Memory) 10b, a ROM (Read Only Memory) 10c, an auxiliary storage device 10d, a network interface 10e, a modem 10f, a device interface 10g, an operation section interface 10h, and the like.

The network interface 10e communicates with the terminal device 2 and the like according to a protocol such as a TCP/IP (Transmission Control Protocol/Internet Protocol). As the network interface 10e, an NIC (Network Interface Card), a wireless LAN card or the like is used.

The modem 10f exchanges image data with a facsimile terminal according to a protocol such as G3.

The device interface 10g is an interface for connecting the scanner unit 14C and the printer unit 14D to the control section 10.

The operation section interface 10h is an interface for connecting the touch panel display 14A and the operation key panel 14B to the control section 10.

The touch panel display 14A displays a screen for displaying a message to a user, a screen for a user to input a command or information, a screen for displaying the result of a process performed by the CPU 10a, and the like.

The operation key panel 14B is a so-called hardware keyboard, and is configured from a numeric keypad, a start key, a stop key, function keys, and the like.

The scanner unit 14C reads an image on a sheet set on platen glass, and generates image data.

The printer unit 14D prints the image read by the scanner unit 14C. That is, it performs a copying process together with the scanner unit 14C and the like.

Furthermore, the printer unit 14D prints an image on paper based on image data received from the terminal device 2, a facsimile terminal or the like by the network interface 10e or the modem 10f.

Programs for realizing the functions of copying and the like described above are stored in the ROM 10c or the auxiliary storage device 10d. Further, a file providing program 10P is stored. With the file providing program 10P, a file saved in a box 1BX may be provided to the terminal device 2.

In addition, programs for realizing functions of OCR (Optical Character Recognition) and reproduction of animation are stored in the image forming device 1. A user may convert an image of a character string read by the scanner unit 14C to text data by OCR, or may reproduce animation by operating the touch panel display 14A or the operation key panel 14B.

These programs are loaded into the RAM 10b as necessary, and are executed by the CPU 10a. As the auxiliary storage device 10d, a hard disk or an SSD (Solid State Drive) is used, for example.

The terminal device 2 is a client for remotely using the functions described above of the image forming device 1. Further, the terminal device 2 is provided with a web browser, and is capable of accessing the image forming device 1 to download files saved in the box.

As the terminal device 2, a personal computer, a smartphone, a tablet computer, or a mobile phone terminal is used, for example.

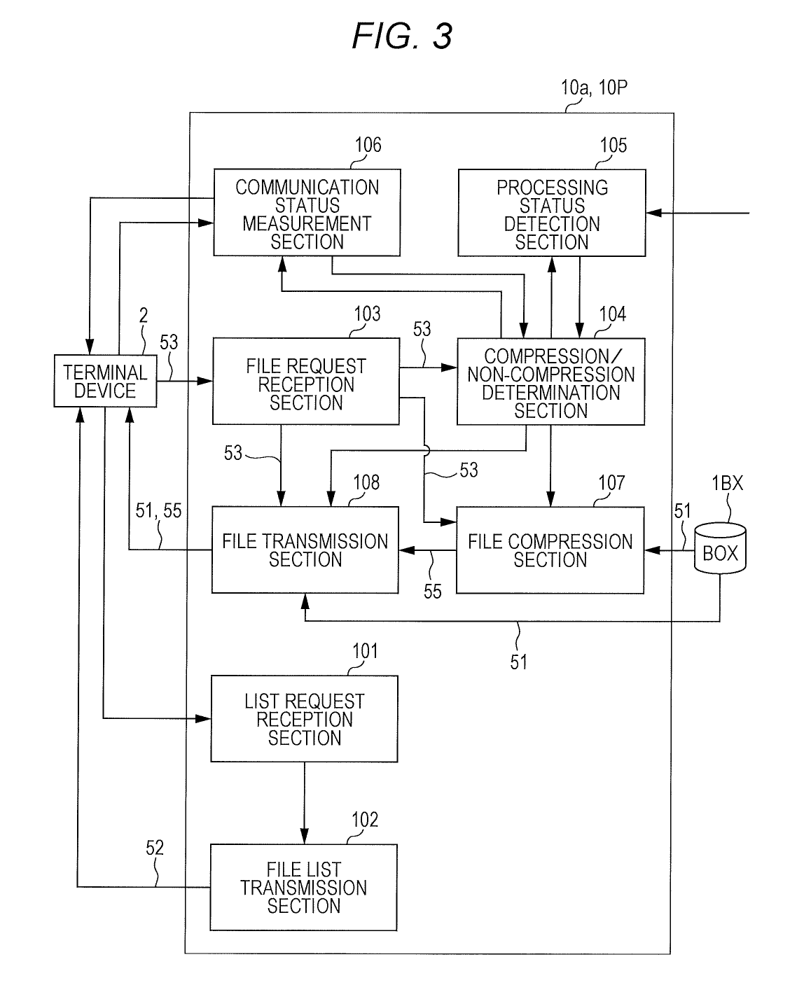

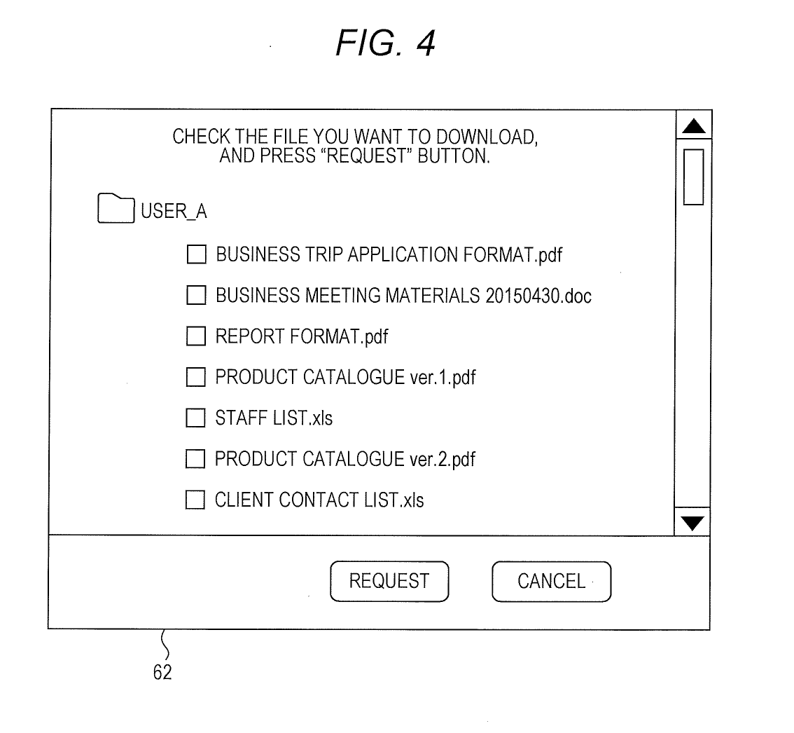

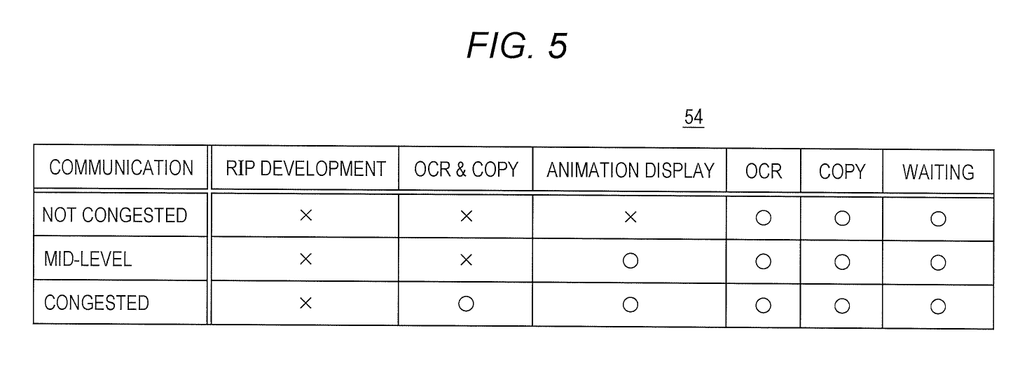

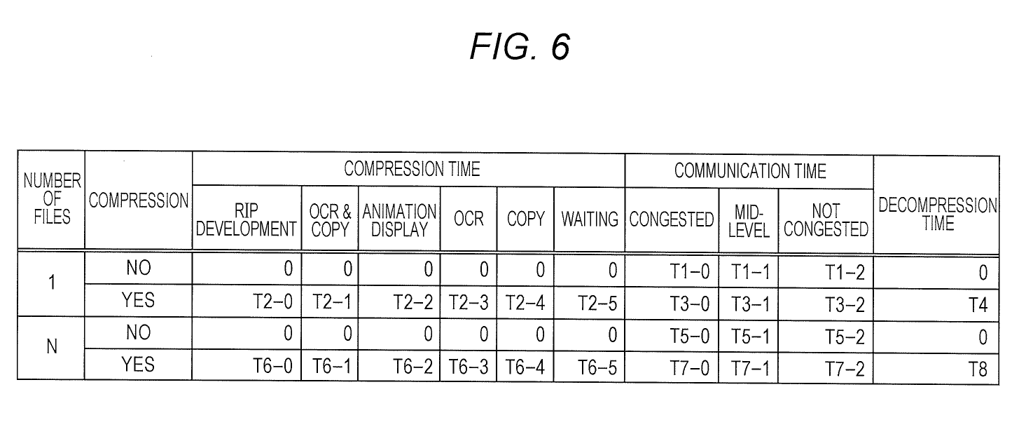

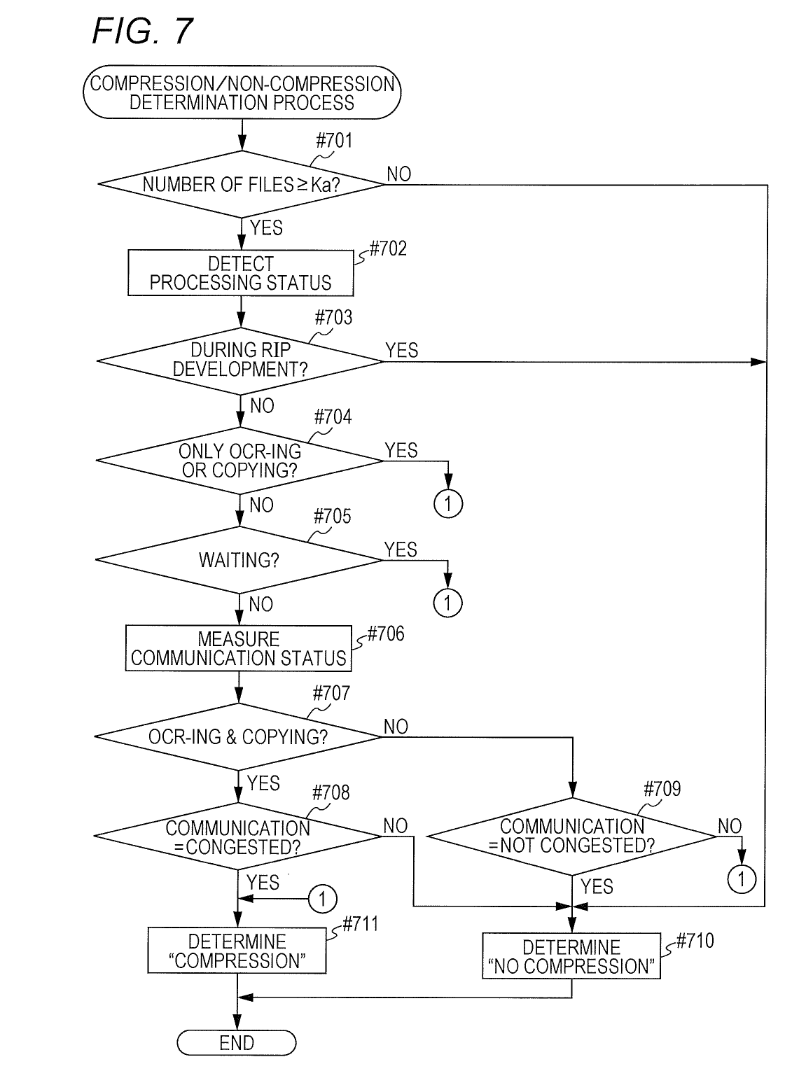

FIG. 3 is a diagram showing an example functional configuration of the image forming device 1. FIG. 4 is a diagram showing an example of a web page 62. FIG. 5 is a diagram showing an example of a standard table 54. FIG. 6 is a diagram showing an example of relationships of compression times and the like at the time of execution of specific processes. FIG. 7 is a flow chart describing an example of a flow of a compression/non-compression determination process.

Hereinafter, a mechanism of provision of a file saved in the box 1BX to the terminal device 2 will be described with reference to FIG. 3 and the like.

With the file providing program 10P, functions of a list request reception section 101, a file list transmission section 102, a file request reception section 103, a compression/non-compression determination section 104, a processing status detection section 105, a communication status measurement section 106, a file compression section 107, a file transmission section 108, and the like shown in FIG. 3 are realized by the image forming device 1.

A user starts a web browser on the terminal device 2. Then, a predetermined URL (Uniform Resource Locator) is input to the web browser.

Then, the terminal device 2 accesses the image forming device 1 based on the URL, and requests for a web page. At this time, a HTTP (Hypertext Transfer Protocol) is used as the protocol.

In the image forming device 1, the list request reception section 101 receives a request for the web page from the terminal device 2.

Then, the file list transmission section 102 transmits web page data 52 for displaying a web page 62 to the terminal device 2. The web page 62 shows a list of files 51 stored in the box 1BX, as shown in FIG. 4.

When the web page data 52 is received, the terminal device 2 displays the web page 62 based on the web page data 52.

Here, the user selects a file 51 the user wants to use from the web page 62. It is possible to select one or a plurality of files 51.

Then, the terminal device 2 transmits file request data 53 to the image forming device 1. One or a plurality of files 51 selected by the user are indicated by the file request data 53.

In the image forming device 1, the file request reception section 103 receives the file request data 53.

Then, the compression/non-compression determination section 104 performs a process of determining whether the file(s) 51 indicated by the file request data 53 should be compressed or not, in cooperation with the communication status measurement section 106 and the processing status detection section 105.

In the case where the number of files 51 indicated by the file request data 53 is less than a predetermined number Ka, the compression/non-compression determination section 104 determines that compression should not be performed.

On the other hand, in the case where the number of files 51 is equal to or greater than the predetermined number Ka, determination is performed in the following manner. The compression/non-compression determination section 104 includes a standard table 54 as shown in FIG. 5, and determines whether to compress the files 51 or not, based on the standard table 54. In the standard table 54, “◯” means that compression should be performed, and “×” means that compression should not be performed.

The processing status detection section 105 detects a process that is currently being performed by the image forming device 1. In the present embodiment, detection is performed regarding whether each of the following four processes is currently being performed or not: a process of rasterization (bit map development) by RIP, a process of converting image data to text data by OCR, a process of copying (duplication), and a process of reproducing animation by the touch panel display 14A. Detection may be performed by making an inquiry to an OS (Operating System).

The communication status measurement section 106 measures the status of a communication channel between the image forming device 1 and the terminal device 2. In the present embodiment, the status of congestion (the degree of jamming) in a round-trip communication channel between the devices is measured.

Specifically, the communication status measurement section 106 measures the time between transmission of a specific packet to the terminal device 2 and reception of a reply from the terminal device 2 (hereinafter referred to as a “round-trip time Ta”). A longer time indicates more congestion in the communication channel. The round-trip time Ta may be measured by a ping. If the round-trip time Ta is equal to or greater than a first threshold Tm, the level of congestion is determined to be “congested”. If the round-trip time Ta is less than a second threshold Tn, “not congested” is determined. Here, Tm is greater than Tn. If the round-trip time Ta is equal to or greater than the second threshold Tn and less than the first threshold Tm, “mid-level” is determined.

Then, the compression/non-compression determination section 104 determines whether or not the file(s) 51 should be compressed, by applying the result of detection by the processing status detection section 105 and the result of determination by the communication status measurement section 106 to the standard table 54.

That is, the compression/non-compression determination section 104 places a focus on a row, in the standard table 54, corresponding to the level of congestion determined by the communication status measurement section 106. For example, in the case where “congested” is determined, the focus is placed on the lowermost row. Then, the focus is placed on a cell, in the focused row, corresponding to the process, detected by the processing status detection section 105, that is currently being performed.

Moreover, in the case where there are a plurality of such cells, the compression/non-compression determination section 104 places the focus on the leftmost cell among the cells. The reason is as follows.

The load on the image forming device 1 (particularly, the CPU 10a) is greater as the process is more to the left. Therefore, as shown in FIG. 6, if compression is performed in parallel with the process in each cell, the time taken by compression is longer for the cell on the left. Furthermore, “×” is set in the standard table 54 for a process for which it is estimated that the time required for compression in the case of parallel execution will be longer than a predetermined standard.

Here, the values in FIG. 6 have the following relationships.

T1_0>T1_1>T1_2

T2_0>T2_1>T2_2>T2_3>T2_4>T2_5

T3_0>T3_1>T3_2

T4_0>T4_1>T4_2>T4_3>T4_4>T4_5

T5_0>T5_1>T5_2

T6_0>T6_1>T6_2>T6_3>T6_4>T6_5

T7_0>T7_1>T7_2

Moreover, in the case where there are a plurality of cells on which the focus will possibly be placed, in order to prevent the load on the image forming device 1 from becoming too great, the compression/non-compression determination section 104 places the focus on the leftmost cells among the cells.

For example, in the case where the process of RIP is being performed, the focus is placed on the sixth cell from the right. Further, in the case where the process of OCR and the process of copying are being performed, the focus is placed on the fifth cell from the right. Furthermore, in the case where the process of displaying animation and the process of copying are being performed, since there is no cell that corresponds to the combination, the focus is placed on the cell that is on the left between the fourth cell from the right, corresponding to the former, and the second cell from the right, corresponding to the latter. That is, the focus is placed on the fourth cell from the right. Moreover, in the case where none of the four processes mentioned above is being performed (that is, in the case of waiting with respect to all the four processes), the focus is placed on the first cell from the right.

Then, in the case where the value in the focused cell is “◯”, the compression/non-compression determination section 104 determines that the file(s) 51 should be compressed. On the other hand, compression is determined not to be performed in the case of “×”.

The predetermined number Ka may be freely set, but is desirably “2”. That is, cases are desirably distinguished based on whether the number of files 51 indicated by the file request data 53 is singular or plural.

Alternatively, the compression/non-compression determination section 104 may determine whether compression should be performed or not by the procedure shown in FIG. 7.

In the case where the number of files indicated by the file request data 53 is less than the predetermined number Ka (#701 in FIG. 7: No), the compression/non-compression determination section 104 determines that compression should not be performed (#710).

On the other hand, in the case where the number of files is equal to or greater than the predetermined number Ka (#701: Yes), the compression/non-compression determination section 104 causes the processing status detection section 105 to detect whether the four processes mentioned above are currently being performed or not (#702).

In the case where the process of RIP is being performed (#703: Yes), the compression/non-compression determination section 104 determines that compression should not be performed (#710).

In the case where only the process of OCR or the process of copying, among the four processes, is being performed (#704: Yes), the compression/non-compression determination section 104 determines that compression should be performed (#711).

In the case where none of the four processes is being performed, that is, during waiting (#705: Yes), the compression/non-compression determination section 104 determines that compression should be performed (#711).

In cases other than the above cases (#703: No, #704: No, #705: No), the compression/non-compression determination section 104 causes the communication status measurement section 106 to measure the round-trip time Ta and to determine the level of congestion in the communication line (#706).

In the case where both the process of OCR and the process of copying are being performed (#707: Yes), and the level of congestion is “not congested” or “mid-level” (#708: No), the compression/non-compression determination section 104 determines that compression should not be performed (#710). On the other hand, if the level of congestion is “congested” (#708: Yes), compression is determined to be performed (#711).

In the case where the process of displaying animation is being performed (#707: No), and the level of congestion is “congested” or “mid-level” (#709: No), the compression/non-compression determination section 104 determines that compression should be performed (#711). On the other hand, if the level of congestion is “not congested” (#709: Yes), compression is determined not to be performed (#710).

Referring back to FIG. 3, when it is determined by the compression/non-compression determination section 104 that the file(s) 51 indicated by the file request data 53 should be compressed, the file compression section 107 reads the file(s) 51 from the box 1BX and compresses the same. Hereinafter, a file 51 which is compressed will be referred to as a “compressed file 55”. As the format of compression, ZIP or LZH is used, for example.

Additionally, the file compression section 107 may group a plurality of files 51 into one folder and compress the folder, or may separately compress each of the plurality of files 51.

In the case where it is determined by the compression/non-compression determination section 104 that the file(s) 51 indicated by the file request data 53 should not be compressed, the file transmission section 108 reads the file(s) 51 from the box 1BX and transmits the same to the terminal device 2 without compression being performed. In the case where the file(s) 51 is/are compressed by the file compression section 107, the file(s) 51 which is/are compressed, that is, the compressed file(s) 55, is/are transmitted to the terminal device 2.

Then, the terminal device 2 receives the file(s) 51 or the compressed file(s) 55 from the image forming device 1 by the web browser.

At this time, the terminal device 2 acquires a MIME (Multipurpose Internet Mail Extensions) type from the image forming device 1. The terminal device 2 may identify the format of a received file (a file 51 or a compressed file 55) according to the MIME type, and may process the same. For example, if the format of a received file 51 is PDF (Portable Document Format), an application for PDF may be started to open the file 51. If the format is ZIP, the compressed file 55 may be saved in a default folder, or a dialog box for specifying the save location is displayed.

In the case of requesting for less than the predetermined number Ka of files 51, the user may acquire the file(s) 51 in a non-compressed manner. Accordingly, a task of editing or printing the file(s) 51 may be performed without performing an operation of decompression (extension). On the other hand, in the case where the predetermined number Ka of files 51 or a greater number of files 51 have been requested, the files 51 may be swiftly acquired and be saved in the terminal device 2.

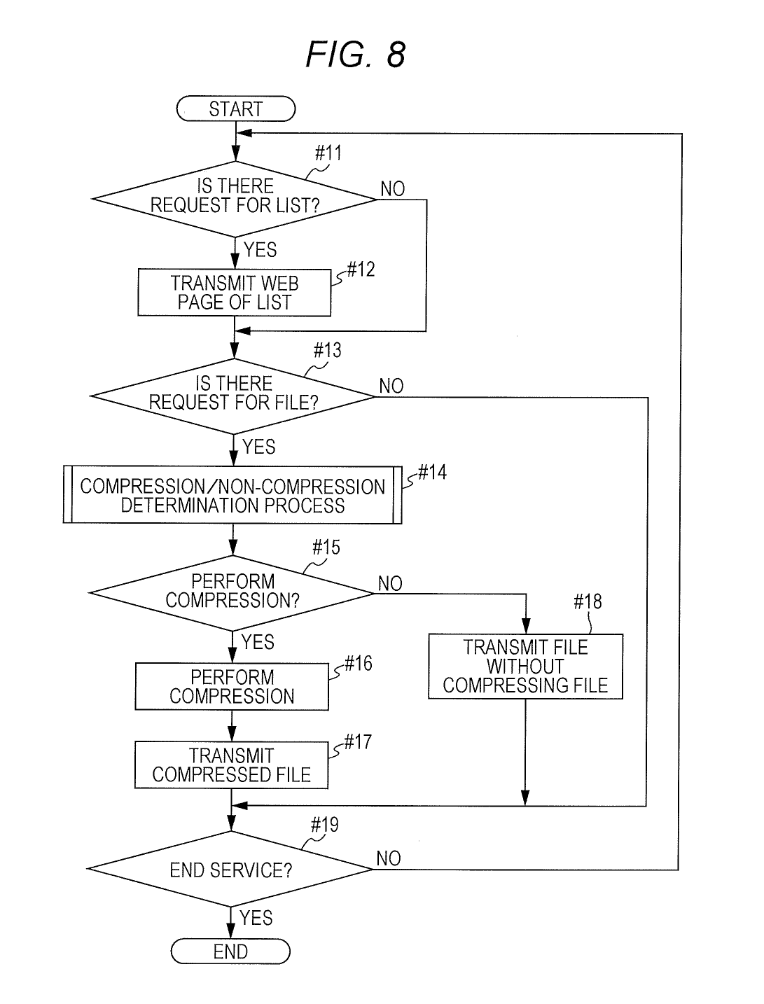

FIG. 8 is a flow chart describing an example of an overall flow of a process according to the file providing program 10P.

The flow of a process performed by the image forming device 1 according to the file providing program 10P will be described below with reference to the flow chart in FIG. 8.

When requested for a web page of a list by the terminal device 2 (#11 in FIG. 8: Yes), the image forming device 1 transmits the web page data 52 of the web page 62 (see FIG. 4) to the terminal device 2 (#12).

Alternatively, when the file request data 53 is received (#13: Yes), whether the file 51 indicated by the file request data 53 should be compressed or not is determined (#14). This determination is performed based on the standard table 54 (see FIG. 5). Alternatively, it may be performed according to the procedure shown in FIG. 7.

In the case where compression is determined (#15: Yes), the image forming device 1 reads the file 51 indicated by the file request data 53 from the box 1BX, and compresses the same (#16). The compressed file 55 is thereby created. Then, the compressed file 55 is transmitted to the terminal device 2 (#17).

On the other hand, if compression is determined not to be performed (#15: No), the image forming device 1 reads the file 51 indicated by the file request data 53 from the box 1BX, and transmits the same to the terminal device 2 without performing compression (#18).

During provision of the service of file transmission, the image forming device 1 performs the process of step #12 or the processes from step #14 to step #18 as appropriate every time there is a request from the terminal device 2.

According to the present embodiment, the user is able to download a small number (less than the predetermined number Ka) of files 51 in a non-compressed manner, and may immediately use the file(s) 51 without decompressing the same. On the other hand, if a specific condition is satisfied, a large number (equal to or more than the predetermined number Ka) of files 51 maybe downloaded in a short time in a compressed form and be saved in the terminal device 2.

In the case where a small number of files 51 are downloaded, the files 51 are, in many cases, used for editing or printing. In the case where a large number of files 51 are downloaded, the files 51 are, in many cases, saved without being used. In this manner, with the present embodiment, the convenience in the provision of the files 51 to a user may be increased compared to the past.

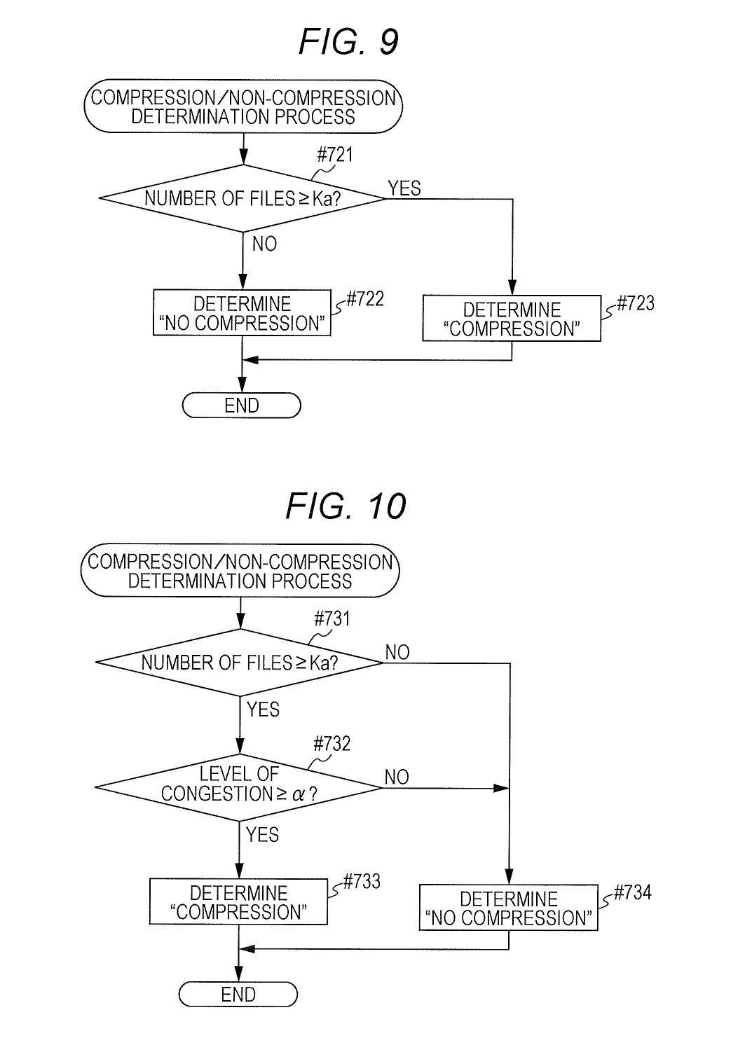

FIGS. 9, 10 and 11 are flow charts describing example modifications of the flow of the compression/non-compression determination process.

In the present embodiment, in a case where the number of files 51 indicated by the file request data 53 is equal to or more than the predetermined number Ka, the compression/non-compression determination section 104 (see FIG. 3) determines whether the files 51 should be compressed or not, according to the level of congestion in the communication channel or the process that is currently being performed. However, in such a case, compression may be determined to be performed regardless of the level of congestion in the communication channel or the process that is currently being performed. That is, the process shown in FIG. 9 may be performed instead of the process shown in FIG. 7.

In the case where the number of files indicated by the file request data 53 is less than the predetermined number Ka (#721: No), the compression/non-compression determination section 104 of the image forming device 1 determines that compression should not be performed (#722). On the other hand, in the case where the number of files is equal to or more than the predetermined number Ka (#721: Yes), compression is determined to be performed (#723).

Furthermore, in the case where the number of files 51 indicated by the file request data 53 is equal to or more than the predetermined number Ka, the compression/non-compression determination section 104 may determine whether the files 51 should be compressed or not, according to the level of the congestion in the communication channel between the image forming device 1 and the terminal device 2, as shown in FIG. 10.

That is, in the case where the number of files 51 indicated by the file request data 53 is less than the predetermined number Ka (#731: No), the compression/non-compression determination section 104 determines that the file(s) 51 should not be compressed (#734). In the case where the number of files 51 is equal to or more than the predetermined number Ka (#731: Yes), if the level of congestion is equal to or greater than a predetermined level (for example, in the case where the communication time measured by a ping is equal to or longer than a predetermined period of time) (#732: Yes), compression is determined to be performed (#733), and if the level is less than the predetermined level (#732: No), compression is determined not to be performed (#734).

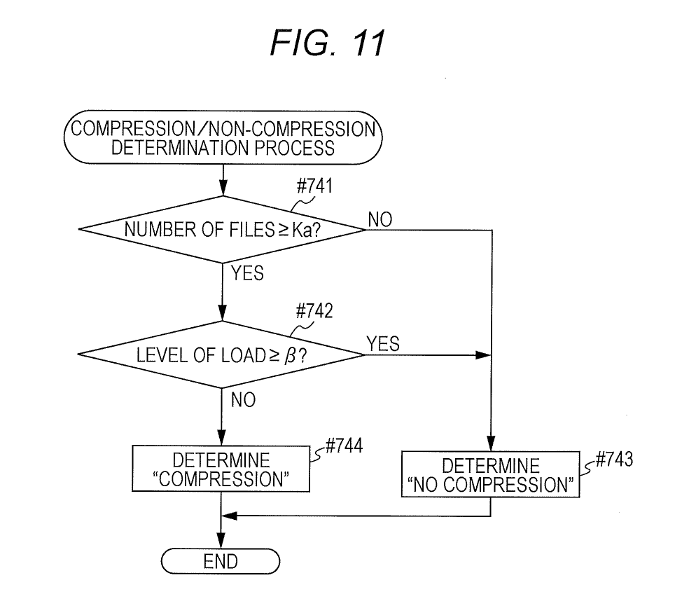

Alternatively, in the case where the number of files 51 indicated by the file request data 53 is equal to or more than the predetermined number Ka, the compression/non-compression determination section 104 may determine whether the files 51 should be compressed or not, according to the level of the load on the image forming device 1, as shown in FIG. 11. The current usage rate of the CPU 10a may be used as the level of the load.

That is, in the case where the number of files 51 indicated by the file request data 53 is less than the predetermined number Ka (#741: No), the compression/non-compression determination section 104 determines that the file(s) 51 should not be compressed (#743). In the case where the number of files 51 is equal to or more than the predetermined number Ka (#741: Yes), if the level of the load is equal to or greater than a predetermined level (#742: Yes), compression is determined not to be performed (#743), and if the level is less than the predetermined level (#742: No), compression is determined to be performed (#744).

In the present embodiment, the process of RIP, the process of OCR, the process of copying, and the process of displaying animation are cited as examples of subjects for which current execution/non-execution is to be determined, but other processes may also be included. In this case, the standard table 54 (see FIG. 5) may be prepared in advance according to the loads of the other processes on the image forming device 1.

In the present embodiment, the communication status measurement section 106 determines the level of congestion based on the time taken by a packet to make a round-trip communication channel between the image forming device 1 and the terminal device 2 (i.e. the round-trip time Ta), but the level of congestion may alternatively be determined based on the time taken by a packet to reach the terminal device 2 from the image forming device 1.

Additionally, the overall configurations or the configurations of respective sections of the document management system 4 and the image forming device 1, the processing contents, the order of processes, the configurations of screens, and the like may be appropriately modified according to the purpose of the present invention.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A data providing device comprising a transmission unit configured to transmit at least one of a plurality of pieces of data to a terminal device, and a compression unit configured to compress the at least one of the plurality of pieces of data, the data providing device comprising:
a reception unit configured to receive, from the terminal device, specification of one or a plurality of pieces of target data that are transmission targets among the plurality of pieces of data,
wherein, in a case where the number of pieces of the one or the plurality of pieces of target data is less than a predetermined number, the transmission unit transmits the target data to the terminal device without the compression unit compressing the target data.

2. The data providing device according to claim 1, wherein, in a case where the number of pieces of the one or the plurality of pieces of target data is equal to or more than the predetermined number, the transmission unit transmits the target data after the target data is compressed by the compression unit.

3. The data providing device according to claim 1, wherein, in a case where the number of the one or the plurality of pieces of target data is equal to or more than the predetermined number, if a degree of congestion in a communication channel between the terminal device and the data providing device is equal to or greater than a predetermined level, the transmission unit transmits the target data after the target data is compressed by the compression unit, and if the degree of congestion is less than the predetermined level, the transmission unit transmits the target data without the compression unit compressing the target data.

4. The data providing device according to claim 1, wherein, in a case where the number of the one or the plurality of pieces of target data is equal to or more than the predetermined number, if a level of a current load on the data providing device is equal to or greater than a predetermined level, the transmission unit transmits the target data without the compression unit compressing the target data, and if the level of the current load is less than the predetermined level, the transmission unit transmits the target data after the target data is compressed by the compression unit.

5. The data providing device according to claim 1, wherein, in a case where the number of the one or the plurality of pieces of target data is equal to or more than the predetermined number, if the data providing device is performing a specific process, the transmission unit transmits the target data without the compression unit compressing the target data.

6. The data providing device according to claim 5, wherein the specific process is a process of raster image processor (RIP).

7. The data providing device according to claim 1, wherein, in a case where the number of the one or the plurality of pieces of target data is equal to or more than the predetermined number, if the data providing device is not performing any of a plurality of specific processes, the transmission unit transmits the target data after the target data is compressed by the compression unit.

8. The data providing device according to claim 7, wherein the plurality of specific processes are a process of RIP, a process of optical character recognition (OCR), a process of copying, and a process of displaying animation.

9. The data providing device according to claim 1, wherein, in a case where the number of the one or the plurality of pieces of target data is equal to or more than the predetermined number, and the data providing device is performing only a process of OCR and a process of copying among a process of RIP, the process of OCR, the process of copying and a process of displaying animation, if a level of congestion in a communication channel between the terminal device and the data providing device is equal to or greater than a predetermined level, the transmission unit transmits the target data after the target data is compressed by the compression unit, and if the level of congestion is less than the predetermined level, the transmission unit transmits the target data without the compression unit compressing the target data.

10. The data providing device according to claim 1, wherein, in a case where the number of the one or the plurality of pieces of target data is equal to or more than the predetermined number, and the data providing device is performing only a process of displaying animation among a process of RIP, a process of OCR, a process of copying and the process of displaying animation, if a level of congestion in a communication channel between the terminal device and the data providing device is equal to or greater than a predetermined level, the transmission unit transmits the target data after the target data is compressed by the compression unit, and if the level of congestion is less than the predetermined level, the transmission unit transmits the target data without the compression unit compressing the target data.

11. A data providing method for compressing at least one of a plurality of pieces of data and providing the data to a terminal device, the method comprising:
receiving, from the terminal device, specification of one or a plurality of pieces of target data that are transmission targets among the plurality of pieces of data; and
transmitting, in a case where the number of pieces of the one or the plurality of pieces of target data is less than a predetermined number, the target data to the terminal device without compressing the target data.

12. A non-transitory recording medium storing a computer readable program to be executed by a computer of a data providing device for providing at least one of a plurality of pieces of data to a terminal device, the data providing device including a compression unit for compressing the at least one of the plurality of pieces of data, wherein the program causes the computer to perform:
receiving, from the terminal device, specification of one or a plurality of pieces of target data that are transmission targets among the plurality of pieces of data, and
transmitting, in a case where the number of pieces of the one or the plurality of pieces of target data is less than a predetermined number, the target data to the terminal device without compressing the target data by the compression unit.

13. The non-transitory recording medium storing a computer readable program according to claim 12, wherein, in the transmitting, in a case where the number of pieces of the one or the plurality of pieces of target data is equal to or more than the predetermined number, the target data is transmitted after being compressed by the compression unit.

14. The non-transitory recording medium storing a computer readable program according to claim 12, wherein, in the transmitting, in a case where the number of the one or the plurality of pieces of target data is equal to or more than the predetermined number, if a degree of congestion in a communication channel between the terminal device and the data providing device is equal to or greater than a predetermined level, the target data is transmitted after being compressed by the compression unit, and if the degree of congestion is less than the predetermined level, the target data is transmitted without being compressed by the compression unit.

15. The non-transitory recording medium storing a computer readable program according to claim 12, wherein, in the transmitting, in a case where the number of the one or the plurality of pieces of target data is equal to or more than the predetermined number, if a level of a current load on the data providing device is equal to or greater than a predetermined level, the target data is transmitted without being compressed by the compression unit, and if the level of the current load is less than the predetermined level, the target data is transmitted after being compressed by the compression unit.

16. The non-transitory recording medium storing a computer readable program according to claim 12, wherein, in the transmitting, in a case where the number of the one or the plurality of pieces of target data is equal to or more than the predetermined number, if the data providing device is performing a specific process, the target data is transmitted without being compressed by the compression unit.

17. The non-transitory recording medium storing a computer readable program according to claim 16, wherein the specific process is a process of raster image processor (RIP).

18. The non-transitory recording medium storing a computer readable program according to claim 12, wherein, in the transmitting, in a case where the number of the one or the plurality of pieces of target data is equal to or more than the predetermined number, if the data providing device is not performing any of a plurality of specific processes, the target data is transmitted after being compressed by the compression unit.

19. The non-transitory recording medium storing a computer readable program according to claim 18, wherein the plurality of specific processes are a process of RIP, a process of optical character recognition (OCR), a process of copying, and a process of displaying animation.

20. The non-transitory recording medium storing a computer readable program according to claim 12, wherein, in the transmitting, in a case where the number of the one or the plurality of pieces of target data is equal to or more than the predetermined number, and the data providing device is performing only a process of OCR and a process of copying among a process of RIP, the process of OCR, the process of copying and a process of displaying animation, if a level of congestion in a communication channel between the terminal device and the data providing device is equal to or greater than a predetermined level, the target data is transmitted after being compressed by the compression unit, and if the level of congestion is less than the predetermined level, the target data is transmitted without being compressed by the compression unit.

21. The non-transitory recording medium storing a computer readable program according to claim 12, wherein, in the transmitting, in a case where the number of the one or the plurality of pieces of target data is equal to or more than the predetermined number, and the data providing device is performing only a process of displaying animation among a process of RIP, a process of OCR, a process of copying and the process of displaying animation, if a level of congestion in a communication channel between the terminal device and the data providing device is equal to or greater than a predetermined level, the target data is transmitted after being compressed by the compression unit, and if the level of congestion is less than the predetermined level, the target data is transmitted without being compressed by the compression unit.
